(19) United States
(12) Patent Application Publication
(10) Pub. No.: US 2022/0235186 A1
(43) Pub. Date: Jul. 28, 2022

(54) Natural fiber plastic composite precursor material for compounding, method for preparing thereof and method for preparing natural fiber plastic composite product

(71) Applicant: UPM-Kymmene Corporation, Helsinki (FI)

(72) Inventors: Juha NIKKOLA, Lahti (FI); Ari KINNUNEN, Lahti (FI); Gerhard ERNST, Kraichtal (GE)

(21) Appl. No.: 17/617,618

(22) PCT Filed: Jun. 18, 2019
(86) PCT No.: PCT/FI2019/050467

§ 371 Date: Dec. 9, 2021

(51) Int. Cl. C08J 5/04; B29C 45/00

(52) U.S. Cl. CPC C08J 5/045; B29C 45/0001; B29K 2201/00; C08J 2323/12; C08J 2323/06; B29C 45/0005

(57) ABSTRACT

The present disclosure relates to a natural fiber plastic composite precursor material comprising 80-95% (w/w) cellulosic fibers having an average fiber length less than 1 mm, 3-7% (w/w) coupling agent, 0-7% (w/w) thermoplastic polymer, and 0-1% (w/w) lubricant and/or wax, wherein the material is in form of pellets having a bulk density in the range of 300-700 g/l, and to a method for preparing thereof. The present disclosure also relates to a method for preparing a natural fiber plastic composite product.

### TECHNICAL FIELD

The present application relates to natural fiber plastic composite precursor materials and to methods for preparing thereof. The present application also relates to a method for preparing a natural fiber plastic composite product from the precursor material.

### BACKGROUND

When preparing natural fiber plastic composite materials, fibrous material may be provided as a separate precursor material, which is then combined with plastic material and the mixture is formed into composite materials and products. However the amount of fibrous material which may be included in the precursor material is limited and is usually less than 70% by weight.

If the fiber content of the precursor material rises, the manufacture and handling thereof becomes complicated. The fibrous material is fluffy and in high percentages it is therefore difficult to handle. Mixing of such fiber with plastics is challenging. High amounts of plastics are usually included to enhance the processability of the precursor material, which lowers the fiber content.

It is desired to obtain a precursor material which contains high amount of fibers. It is also desired to obtain material which tolerates handling, transporting and storing, and which is easy to use at the manufacturing site.

### SUMMARY

In the present case it was found out how to enhance the fiber content of a composite precursor material, which may be also called as fiber precursor material, precursor material or precursor. Precursor material was obtained which can be provided at a high fiber content, such as high chemical pulp content, and improved compounding properties, such as dispersion and mechanical strength, in addition with improved moisture repellence. The improved characteristics of the precursor material are thereby available for the compounder, who can benefit of the enhanced compounding properties of the precursor material upon compounding. The fiber precursor material may thus be configured to act as a “master batch”, which in itself promotes easy dispersion of the fibers upon compounding. This is advantageous, as the composite manufacturer can reach a desired fiber content level with better homogeneity and less compounding, which is reflected in better thermomechanical properties of the composite. Furthermore, the composite manufacturer has better capability to choose the fiber content level of the formed polymer composite, which has been difficult in the past, for example due to the agglomeration tendency of bleached chemical pulp within the polymer matrix.

The present application provides a method for preparing a natural fiber plastic composite precursor material for compounding, the method comprising
forming a mixture comprising
   80-95% (w/w) cellulosic fibers having an average fiber length less than 1 mm,
   3-7% (w/w) coupling agent,
   0-7% (w/w) thermoplastic polymer, such as 3-7% (w/w), and
   0-1% (w/w) lubricant and/or wax, such as 0.1-0.5% (w/w), and
forming the mixture in a melt process into pellets having a bulk density in the range of 300-700 g/l to obtain the natural fiber plastic composite precursor material.

The present application also provides a natural fiber plastic composite precursor material for compounding, the material comprising
80-95% (w/w) of cellulosic fibers having an average fiber length less than 1 mm,
3-7% (w/w) coupling agent,
0-7% (w/w) thermoplastic polymer, such as 3-7% (w/w), and
0-1% (w/w) lubricant and/or wax, such as 0.1-0.5% (w/w), wherein the material is in form of pellets having a bulk density in the range of 300-700 g/l.

The present application also provides a method for preparing a natural fiber plastic composite product, the method comprising
providing the natural fiber plastic composite precursor material,
providing thermoplastic polymer,
feeding the natural fiber plastic composite precursor material and the thermoplastic polymer to a forming device, and
forming the materials into a composite product.

The present application also provides use of the natural fiber plastic composite precursor material for preparing a natural fiber plastic composite product, such as by compounding.

The main embodiments are characterized in the independent claims. Various embodiments are disclosed in the dependent claims. The embodiments and examples recited in the claims and in the description are mutually freely combinable unless otherwise explicitly stated.

The obtained natural fiber plastic composite precursor material may contain a very high percentage of fibers, even over 90% by weight. It was found out that when an average fiber length shorter than usually was used, the processability of the fiber was enhanced and it was possible to efficiently mix the fiber with the plastic polymers and to include more fibers in the precursor material. A homogenous precursor product with high fiber content was obtained. Unlike previously though, the short fiber length did not have an adverse effect to the properties of the final product but composite products having good structural and mechanical properties were obtained. The fiber was easy to handle and process.

When very high amounts of fiber are included in the precursor material, the role of the other ingredients becomes higher. The amount of the plastic polymer(s), in general thermoplastic polymer(s) included in the precursor material is relatively low, so the selection of polymers and additives is important. In the present case virgin polymers were used, such as polyolefines.

When lubricant and/or wax were included in the precursor material, it was easier to form the material into products, such as pellets. For example the lubricant enhanced the mixability and extrudability of the material, especially at the interface of the extruder die. Waxes act inside the material and also at the surface of the material and help in the dispersing process, which enables obtaining homogenous material. Especially in products which high bulk density it is advantageous to include wax or lubricant, as the high bulk density products would otherwise be more difficult to process compared to products with a lower bulk density.

When using such additives it was possible to obtain pellets, which could tolerate mechanical stress. This is important for example during storage and transport, wherein it is desired that the material does not crumble or otherwise degrade. Also when compacting the pellets it was possible to use high compression ratios which resulted in formation of compact pellets with high bulk density and good mechanical and structural properties, such as stiffness, hardness and tensile or flexural properties, such as tensile stress, tensile modulus, flexural modulus and flexural stress. Further, as the lubricant and/or wax is already present in the precursor material, it can act also in the preparation of the final composite products, which simplifies the process as it may not be necessary to add such additives separately, or less additives need to be added. The compounding of the polymer(s) and fibers in the preparation of composite materials was improved.

The above mentioned properties of the obtained pellets enable providing an intermediate precursor product which may be provided for the preparation of natural fiber plastic composite products. In practice homogeneous free-flowing pellets are obtained, which for example do not contain fiber bundles or the like aggregates which could have a negative effect to the mechanical properties and quality of the obtained materials. Such pellets can be stored, transported and handled without problems. For example the material does not dust which is especially desired at the production sites. Further, the material already contains additives which can be utilized in the preparation of final composite products. The storage and transport of such precursor products is cost effective. In several processes, such as extrusion and injection moulding, easily dosable pellets facilitate the process and enable good production. It was also found out that by using pellets it is possible to obtain a higher fiber content in the final composite product when compared for example only extruding the raw materials. Further, as the pellets contain mostly fibers and only a small amount of other ingredients, they can be used in a variety of compounding processes utilizing different thermoplastics and other compounds. Therefore the use of the pellets is not limited to specific compounding types or materials.

### BRIEF DESCRIPTION OF THE FIGURES

FIG. 1 shows the effect of processing temperature on mechanical properties in the melt-blending of the masterbatch

FIG. 2 shows samples of different natural fiber plastic composite products obtained by compounding

FIG. 3 shows tensile stress and tensile modulus of samples comprising 40% (w/w) fiber in polypropylene matrix

FIG. 4 shows flexural stress and flexural modulus of samples comprising 40% (w/w) fiber in polypropylene matrix

FIG. 5 shows impact strength of samples comprising 40% (w/w) fiber in polypropylene matrix

FIG. 6 shows the effect of wax or lubricant to tensile stress and tensile modulus

FIG. 7 shows the effect of wax or lubricant to flexural stress and tensile modulus

FIG. 8 shows the effect of wax or lubricant to impact strength

### DETAILED DESCRIPTION

All the percentage values disclosed herein refer to percentages by weight (w/w) of dry weights unless otherwise mentioned. The sum of the ingredients, such as fibers, polymers, fillers and additives, in the embodiments and examples disclosed herein adds up to 100% (w/w). The open term “comprise” also includes the closed term “consisting of” as one option.

When forming natural fiber composite materials, a masterbatch material may be first formed or provided. The masterbatch may be then compounded into a compound material. In compounding cellulose fiber-based polymer composites are manufactured by compounding together polymer and cellulose fiber-based material in order to achieve a homogenous blend of the two different raw materials, which remain separate and distinct within the finished structure. The polymer binds the composite materials together, while the cellulose fiber-based material typically reinforces the composite. Compounding involves that the polymer obtains a molten state, whereas the cellulose fiber-based material remains solid. As the components are dosed automatically via feeders, hoppers or the like into the forming device, the mixing, as well as temperature control, are important factors in the composite compounding.

Finally the molten mixture of the materials is molded and/or formed into the final composite product. Because in the compounding at least fibers and thermoplastic polymers are combined, it is possible to provide these materials as separate precursor products, which are formed into forms which can be stored, transported, provided and handled without problems. Herein such a precursor fiber product and manufacture thereof is described.

The present application discloses a method for preparing a natural fiber plastic composite precursor material, the method comprising
providing cellulosic fibers having an average fiber length less than 1 mm and preferably a bulk density in the range of 40-100 g/l,
providing thermoplastic polymer,
providing coupling agent,
optionally providing lubricant and/or wax,
forming the ingredients into a mixture.

The “ingredients” comprise at least cellulosic fibers, coupling agent and preferably thermoplastic polymer, lubricant and/or wax. Additives, such as ones disclosed herein, may be also included as ingredients. Forming the ingredients into a mixture comprises combining and mixing the ingredients, either all at the same time or substantially at the same time, or first combining two or more ingredients and then adding one or more or all of the rest ingredients. For example the fibrous material and the coupling agent may be combined and mixed first, or the thermoplastic polymer and the coupling agent, optionally also the fibrous material, may be combined and mixed first. Preferably at least these ingredients are melt-blended, i.e. mixed and heat-treated, to obtain a mixture, which can be used in the further compounding steps.

The cellulosic fibers may comprise or consist of pulp. Pulp is a lignocellulosic fibrous material prepared by chemically or mechanically separating cellulose fibers from materials such as wood, fiber crops, waste paper, or rags. Examples of pulp include chemical pulp, mechanical pulp and chemithermomehcanical pulp The properties of mechanical pulp however are inferior compared to chemical pulp. Mechanical pulping is not designed to remove lignin from the wood, whereby lignin remains to a large extent in mechanical pulp. Lignin can begin to participate in condensation reactions already at a temperature as low as 90° C. The condensation reactions are accelerated considerably when the temperature reaches 130° C., whereas many polymers require much higher compounding temperatures than this. Thus, compounding easily leads to heat-induced lignin condensation reactions, which may darken the formed product and further produce water that remains entrapped into the composite melt. Upon elevated pressure and temperature the entrapped moisture may evaporate and expand into gaseous phase, which is why the forming moisture would need to be removed. This may be problematic, as upon compounding, the melting polymer encapsulates the pulp-based constituents. It is important to provide the cellulosic fibers in suitable form and to include suitable additives, such as coupling agent(s) and/or wax(es).

Chemical pulping disintegrates the structure of the wood with strong chemicals in a cooking process, thereby producing fibrous material with a very high cellulose fiber content. The purpose of chemical pulping is to degrade and dissolve the lignin in wood so that the cellulose fibers can be separated without mechanical treatment. Compared to mechanical pulping, the chemical cooking also preserves better the original cellulose fiber length. However, this delignification process also degrades considerable amounts of hemicelluloses and in lesser amounts cellulose fibers. For this reason, the delignification process is stopped before significant losses of cellulose and hemicelluloses, while leaving less than 10% of the original lignin in the pulp. The delignification process used to break down lignin is referred to as a chemical cooking. A chemical pulping process thus removes nearly all of the lignin and at least part of the hemicelluloses, while preserving the fiber structure and length better than semi-chemical or mechanical methods. A chemical pulping process therefore provides more processed cellulose fibers that has excellent physical properties, such as stiffness and rigidity, which is not obtained with mechanical or semi-mechanical pulping processes. A chemical pulping process further provides cellulose fibers containing pores. Examples of chemical pulping processes are, for example, the sulphite pulping process or the Kraft pulping process. The Kraft pulping process uses sodium sulphide and alkali to separate cellulose fibers from other compounds in the wood material. Non-limiting examples of chemical pulp are Kraft pulp, sulphite pulp and dissolving pulp.

The remaining lignin in the chemical pulp can be further removed through bleaching processes, thereby providing bleached chemical pulp. Bleached chemical pulp typically contains lignin in an amount of less than 1 wt. % of the bleached chemical pulp. Bleaching is typically performed in multi-stage sequence of steps, which utilize different bleaching chemicals. Typical bleaching chemical include chlorine dioxide (ClO₂), hypochlorite (NaClO), oxygen (O₂), hydrogen peroxide (H₂O₂), and ozone (O₃). All of these bleaching chemicals are oxidative, and therefore the bleaching reactions can be considered as oxidation reactions. The first bleaching steps are further delignification stages, whereas the later steps are brightening stages, in which the brown-colour inducing chromophores are removed, thereby increasing the pulp whiteness and brightness. Brightness may be advantageous in fiber-based polymer composite objects wherein lighter colours or paintability is preferred.

Bleached chemical pulp presents superior properties when compared to conventional wooden material in fiber-based polymer composites. The Kraft process, in particular, decreases considerably the amounts of hemicelluloses, lignin, wood extractives and inorganics in the pulp material such that only residual traces of these compounds remain; thereby the bleached chemical pulp may be denoted as essentially ‘lignin free’. This has three main effects on the properties of the bleached chemical pulp containing cellulose fibers. First, the bleached chemical pulp if stiff and strong, because the flexible lignin and hemicellulose components are mostly removed. Thus, the highly ordered, rigid cellulose fibers may be used to provide a reinforcing effect on a fiber-based polymer composite. Second, cellulose fibrils and hydroxyl groups become more accessible on the surface of the cellulose fibers. This enables surface interactions of the cellulose fibers with matrix materials and additives, such as adsorption agents. Third, the removal of lignin and hemicelluloses from the fibers creates pores into the cellulose fiber structure. The pores may improve the effect of the additives with the cellulose fibers. The removal of lignin also removes most of the aromatic groups from the pulp, which thereby results to a raw material that is less odorous. The chemical pulping method may thus be used to provide a range of highly processed fibrous raw material, which may be further tailored to contain specific properties, which may be transferred to the fiber-based polymer composite.

The cellulosic fibers, such as pulp, may be obtained from softwood, such as spruce, pine, fir, larch, douglas-fir or hemlock, or hardwood, such as birch, aspen, poplar, alder, eucalyptus, or acacia, or a mixture of softwood and hardwood. Preferably the cellulosic fiber material contains little or substantially no impurities, so the material has no impact of the color of the final composite product, and the impurities do not interfere the integrity of the composite material. For example lignin or other impurities, such as impurities in recycled materials such as inks, pigments, silicones and the like, may not be desired in the cellulosic fiber material. Preferably the cellulosic fibers are chemical pulp fibers, such as bleached chemical pulp fiber, for example Kraft pulp fibers. Using such fibers enable obtaining material and products having no interfering basic color, so there is no or less need to add colorants or the like.

Preferably the cellulosic fiber material is pulped material, and does not include wood particles, such as wood dust, saw dust or the like, or other non-pulped wood material. Pulp, as used herein, does not refer to such wood material.

Preferably the cellulosic fibers are dried or provided as dried, and they maybe obtained by refining or otherwise mechanically treating dried cellulosic material, such as cellulosic sheets, recycled materials and the like, to obtain the desired fiber length, bulk density and/or other properties. Preferably the lignin content, or impurity content in general, such as the impurities mentioned herein, in the cellulosic fiber material should be under 5% (w/w), under 3% (w/w), preferably under 1% (w/w) or under 0.5% (w/w). The cellulosic fibers may have a bulk density in the range of 40-100 g/l. such as in the range of 40-80 g/l, and in many cases in the range of 40-60 g/l.

The cellulosic fibers may be virgin fibers, or mainly virgin fibers. For example at least 50% (w/w), at least 60% (w/w), at least 70% (w/w), at least 80% (w/w), at least 90% (w/w), or at least 95% (w/w) of the cellulosic fibers may be virgin fibers, or even 100% (w/w) or about 100% (w/w).

However recycled cellulosic material may be also used. In one embodiment the cellulosic fibers comprise recycled cellulosic fibers, such as from recycled paper and/or cardboard. The recycled fibers may be originated for example from bleached or otherwise white or light-colored recycled materials, such as recycled paper or cardboard cups, plates and the like, which may comprise chemical and/or bleached cellulosic fibers or pulp.

The cellulosic fibers may have an average fiber length of less than 1 mm, more particularly 0.7 mm or less, such as 0.5 mm or less, or less than 0.5 mm, for example in the range of 0.1-1.0 mm, more particularly in the range of 0.1-0.7 mm, preferably in the range of 0.1-0.5 mm or 0.1-0.45 mm. Preferably the length of at least 80% (w/w) of the fibers is in said range, such as at least 90% (w/w). However, the average fiber length should be preferably at least 0.1 mm, preferably at least 0.2 mm, and smaller particles are called powder or fiber-like particles. It was found out that using the relatively short fiber length made the handling and processing of the fibers easier as the material was more compact compared to corresponding fibers with longer fiber length. Such material contains less air which makes it less fluffy compared to conventional fiber materials and therefore easier to process. This however did not had a remarkable effect to the mechanical or structural properties of the final composite products obtained from the precursor material, which was surprising. It was also found out that the shorter fiber length provided good quality products for example in injection molding. The fiber length may be measured for example by using a Fiberlab measuring device, manufactured by Metso.

The desired fiber length may be obtained by mechanically treating fibers with higher fiber length to obtain a shorter fiber length. For example fiber material, such as pulp which may be in a form of pulp sheets or other suitable form, preferably dried, may be refined, ground, sieved and/or otherwise treated to obtain the desired fiber length of less than 1 mm. The preparation method may include, before forming the mixture, mechanically treating fibers to obtain the desired fiber length. The preparation method may also include sieving the mechanically treated fibers to obtain the desired fiber length.

The amount of the cellulosic fibers in the mixture may be 80% (w/w) or more, 85% (w/w) or more or 90% (w/w) or more, such as in the range of 80-95% (w/w). In some examples the amount of cellulosic fibers is in the range of 85-95% (w/w), such as 90-95% (w/w), 90-93% (w/w) or 91-95% (w/w). As the amount of cellulosic fibers is very high, factors such as moisture content must be controlled to obtain products with high structural integrity and durability. The cellulosic fibers may be provided at a low or a lowered moisture content, such as dry or dried, and/or at ambient moisture content. The moisture content of the cellulosic fibers may be 10% or less, such as 7% (w/w) or less or 5% (w/w) or less. Examples of suitable moisture contents include moisture contents in the range of 0-10% (w/w), 0.1-10% (w/w) or 0.1-7% (w/w), such as 0.5-5% (w/w). The method may comprise setting the moisture content into said range, for example by drying. Because of the hygroscopicity of such cellulosic fiber material, the moisture content of the material at ambient conditions may be in the range of 3-10% (w/w).

The fiber material, the mixture or the final product may be studied to analyze the fiber content and/or type. Fiber furnish analysis according to ISO standards ISO 9184-1 and/or 9184-4:1990 may be used in identification of papermaking fibers from pulp material. The analysis may be used, for example, to distinguish cellulose fibers produced by chemical, semi-chemical, such as chemithermomechanical, or mechanical method from each other. The analysis may further be used, for example, in differentiation of cellulose fibers produced by kraft or sulphite process in hardwood pulps and in differentiation of cellulose fibers from softwood and hardwood from each other. Metso Fiber Image Analyzer (Metso FS5) is an example of a device, which can be used according to the manufacturer's instructions to perform the fiber furnish analysis. For example, a high resolution camera may be used to acquire a greyscale image of a sample, of which image the properties of the fibers in the sample may be determined. The greyscale image may be acquired from a sample placed in a transparent sample holder, such as a cuvette, using a 0.5 millimeter depth of focus according to ISO 16505-2 standard. The wood species used in a pulp material may be distinguished by comparison method, wherein a sample fiber is compared against a known reference fiber. Fiber length may be determined according to ISO 16065-N.

The moisture content and fibers content of fiber material may be determined by a thermogravimetric method, which uses a balance unit and a heating unit for determining the weight loss of a sample due to drying. The weight loss in a known amount of fiber material due to drying is directly proportional to the moisture content of the fiber material. When determining the fiber content of precursor material, a modified thermogravimetric method containing two consecutive steps is used, wherein first the moisture content of the precursor material is determined, followed by determination of the fiber content, as disclosed below. The modified thermogravimetric method may, if necessary, be further used for determination of the fiber content of a compounded material, such as a fiber-based polymer composite formed of the precursor material.

An example of a thermogravimetric method for determining the moisture content of a sample is oven drying, wherein the sample is placed in an aluminum container and the initial weight of the sample is determined with 0.001 g accuracy. The sample is then oven dried under laboratory conditions at a temperature of 120° C. for 24 hours, followed by cooling the sample down to room temperature in a desiccator. The dry weight of the sample is then determined with 0.001 g accuracy, thereby obtaining the weight loss of the sample due to oven drying, indicating the moisture content of the sample. The sample may be fiber material or precursor material.

Alternatively, the moisture content may be determined by infrared drying method. Infrared drying has the advantage of being a fast and precise method, when compared to oven drying method. In infrared drying, the sample is placed on a balance unit and heated by an infrared heat source, until the balance unit no longer detects weight loss due to drying. The moisture content of the sample is the total loss in weight due to drying. An example of infrared moisture analyzer suitable for moisture content determination is Sartorius MA100, which may be used according to the manufacturer's instructions. The infrared heat source, such as a halogen lamp, a CQR quartz glass heater or a ceramic heating element, may be selected based on the material to be analyzed.

Once the moisture content of the sample is known, the fiber content of the precursor material may be determined. The fiber content determination is a solvent-based analysis, wherein the thermoplastic compatibilizer (typically a polyolefin based polymer) is dissolved and extracted out of the precursor material with decalin, the remaining fiber is dried and the weight of the dried fiber is determined. Decalin, which refers to decahydronaphthalene and has the formula C₁₀H₁₈ (CAS Registry Number 91-17-8), is an industrial solvent which can dissolve many types of resins, but which is insoluble to water. Therefore, the dry sample from the above-described moisture content determination may be used for the fiber content determination. Alternatively, a fresh sample may be first dried with infrared moisture analyzer or oven dried as described above (120° C., 24 hours) to remove water and determine the moisture content of the sample. Subsequently, an amount in the range of 0.5 to 1 g of the dried material is weighed and added into 80 ml of decalin, thereby forming a mixture. The mixture is allowed to rest for 12 hours, followed by boiling the mixture for 8 hours, to ensure that all of the thermoplastic compatibilizer and/or polymer is dissolved into the decalin. After boiling, the mixture is filtered through a filter paper and the filtrate containing the decalin and the dissolved thermoplastic compatibilizer and/or polymer is discarded. The non-dissolved material remaining on the filter paper is oven dried at a temperature of 102° C. for 24 hours, followed by cooling the dried material down to room temperature in a desiccator. The obtained dried material is the amount of fiber in the sample, which is weighed to calculate the fiber content of the precursor material.

Thermoplastic polymer, also called as plastic or plastic polymer or matrix material, may be provided to the mixture to bind the ingredients together and to form a matrix. Such thermoplastic matrix material is material which preferably can be formed into a new shape several times when it is heated. This material keeps its new shape after cooling and then it flows very slowly, or it does not flow at all. The thermoplastic polymer has/have at least one repeat unit, and molecular weight(s) of the thermoplastic polymer(s) material is/are over 18 g/mol, preferably over 100 g/mol, over 500 g/mol, or over 1000 g/mol, more preferably over 10 000 g/mol or over 100 000 g/mol.

The thermoplastic polymer may comprise one or more thermoplastic polymer(s), such as one or more polyolefin(s), such as polyethylene or polypropylene, and/or polyolefin copolymers such as ethylene-butene, ethylene-octene or ethylene vinyl alcohol, and/or mixtures thereof. Polyethylene and polypropylene are preferred. The thermoplastic polymer may be injection molding grade thermoplastic polymer.

Polyethylene may be classified into several different categories based on density and branching. Examples of such categories include ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (MDPE), linear low-density polyethylene (LLDPE), low-density polyethylene (LDPE), very-low-density polyethylene (VLDPE) and chlorinated polyethylene (CPE). The melting point and glass transition temperature may vary depending on the type of polyethylene. For medium and high-density virgin polyethylene the melting point is typically in the range of 120-180° C., and for average low-density polyethylene in the range of 105-115° C.

Polypropylene is a polyolefin which is suitable for compounding, especially for precursor material pellets with high bulk density, especially in combination with a wax. Such pellets were found to provide enhanced processability and homogeneity.

Also other thermoplastic polymer(s) may be used, such as polymethylpentene or polybutene-1, or polyamide, polyethylene terephthalate (PET), polyvinyl chloride (PVC), polyacrylate, polymethacrylate, polyester, polycarbonate, polystyrene, polystyrene copolymers such as high impact polystyrene or acrylonitrile butadiene styrene copolymer, polyacrylates or polymethacrylate, and/or mixtures and/or copolymers thereof.

The thermoplastic polymer is preferably provided in a powder form, which facilitates the mixing and compacting of the mixture. The amount of the thermoplastic polymer in the mixture or in the final product is relatively low, so even though it is preferred to use the same or similar thermoplastic polymer in the compounding of the final composite material, it may be also possible to use the precursor material with other types of thermoplastic polymers as well in the compounding. This enables a versatile use of the precursor material in a variety of compounding processes. The amount of the thermoplastic polymer may be 7% (w/w) or less, such as in the range of 1-7% (w/w), in most cases in the range of 3-7% (w/w) in the final mixture, such as 4-7% (w/w), for example 4-6% (w/w), 4-5% (w/w) or 4.5-5% (w/w).

One or more coupling agent(s) may be included to improve the formation of polymeric matrix in the material and mixing of the fiber material with the plastic material, such as to improve interfacial wetting of fillers with the polymer matrix. The one or more coupling agent(s) may be also included to bind the fiber material without a separate polymer matrix, and it was found out that it was possible to obtain acceptable pellets with very high fiber content by using coupling agent as the only binding substance without adding any further thermoplastic polymer matrix material. The coupling agent may be a polymeric coupling agent. Preferably a coupling agent which is compatible with the used polymer(s) and/or the fiber material is selected. Polymeric coupling agent preferably contains moiety or moieties, which are reactive or at least compatible with the thermoplastic matrix material and/or moiety or moieties, which are reactive or at least compatible with the cellulosic fiber material. Preferably polymeric coupling agent contains the same repeat units as the thermoplastic material used. Advantageously at least 30% (w/w) or at least 40% (w/w), more preferably at least 50% (w/w) or at least 60% (w/w), and most preferably at least 80% (w/w) or at least 85% (w/w) of the moieties of the polymeric coupling agent are chemically the same as in the thermoplastic material. Advantageously said moiety or moieties which is/are reactive or at least compatible with the cellulosic fiber material comprise(s) anhydride(s), acid(s), alcohol(s), isocyanate(s), and/or aldehyde(s). In one example the coupling agent is acrylic acid grafted polymer and/or the coupling agent is methacrylic acid grafted polymer. Preferably the coupling agent comprises or consists of maleic acid anhydride grafted polymer, such as maleic anhydride grafted or functionalized polyolefin. The coupling agent may, in principle, be any chemical which is able to improve the adhesion between two main components. This means that it may contain moieties or components, which are reactive or compatible with thermoplastic material and moieties or components, which are reactive or compatible with the cellulosic fiber material. Examples of coupling agent comprise or consists of anhydrides, preferably maleic anhydride (MA), polymers and/or copolymers, such as maleic anhydride functionalized HDPE, maleic anhydride functionalized LDPE, maleic anhydride-modified polyethylene (MAHPE), maleic anhydride functionalized EP copolymers, maleated polyethylene (MAPE), maleated polypropylene (MAPP), acrylic acid functionalized PP, HDPE, LDPE, LLDPE, and EP copolymers, styrene/maleic anhydride copolymers, such as styrene-ethylene-butylene-styrene/maleic anhydride (SEBS-MA), and/or styrene/maleic anhydride (SMA), and/or organic-inorganic agents, preferably silanes and/or alkoxysilanes such as vinyl trialkoxy silanes, or combinations thereof.

The coupling agent may be or comprise a maleic anhydride based coupling agent, such as thermoplastic polymer graft maleic anhydride copolymer, preferably olefin-graft maleic anhydride copolymer especially in the case wherein the thermoplastic polymer comprises olefin. Specific examples of coupling agents include polyethylene graft maleic anhydride to be used with polyethylene and polypropylene graft maleic anhydride to be used with polypropylene. The amount of the coupling agent may be in the range of 3-7% (w/w) in the final mixture, such as 4-7% (w/w), 5-7% (w/w) or 5-6% (w/w), for example about 5% (w/w). It was found out that when the content of the coupling agent in the precursor material was high enough, such as about 5-7% (w/w), it still could provide coupling effect in the preparation of the final composite products by using the precursor material.

The coupling agent may be called a thermoplastic compatibilizer, or a thermoplastic compatibilizer may comprise the coupling agent(s) and optionally thermoplastic polymer(s), or it may be formed of coupling agent(s) and thermoplastic polymer(s). The coupling agent(s) and the thermoplastic polymer(s) may be provided as a thermoplastic compatibilizer, or coupling agent(s) and the thermoplastic polymer(s) may be reacted to obtain a thermoplastic compatibilizer. The content of thermoplastic compatibilizer may be in the range of 5-14% (w/w), such as 6-14% (w/w), 8-14% (w/w) or 10-14% (w/w).

Examples of thermoplastic compatibilizer include ones selected from the group of biopolymers, such as bio-polyamide, polylactic acid and cellulose acetate, or synthetic polymers, such as synthetic polyamide, polycarbonates, polyethylene terephthalate, polystyrene, polystyrene copolymers, acrylonitrile-butadiene-styrene copolymer, styrene block copolymers and polyvinyl chloride, or polyolefins, such as polyethylene, high density polyethylene, low density polyethylene, linear low density polyethylene and polypropylene. Bio-polyamides such as polyamide 1010, which is the polycondensation product of 1,10-decamethylene diamine and 1,10-decanedioic diacid, may be obtained by chemical processing of castor oil, thereby providing a biopolymer that has been produced of fully natural raw materials. On the other hand, synthetic polyamides, such as polyamide PA12, which may be obtained from a multi-stage process of butadiene via laurolactam, may be advantageous due to a lower processing temperature around 180° C. and excellent thermomechanical properties of the polymer, despite being a synthetic, non-biodegradable polyamide. A further advantage of polyamide as a thermoplastic compatibilizer may be the chemical compatibility with adsorption agents containing terminal amine groups (—NH₂), such as polyethyleneimine.

The thermoplastic compatibilizer may be used to provide precursor material that has improved dispersion characteristics at a compounding unit, when the precursor material is compounded with a further polymer, such that a composite product with improved mechanical properties may be obtained. The improved mechanical properties may be obtained without concomitant melting of the thermoplastic compatibilizer with the dried fibers upon mixing. Therefore, the thermoplastic compatibilizer preferably has an average particle size of equal to or less than 1 mm, preferably in the range of 100 to 800 micrometers. Preferably, the thermoplastic compatibilizer is polypropylene, preferably polypropylene that has been grafted to contain a coupling agent, such as maleic acid anhydride or a functional silane, for example a vinyl silane or methacrylic silane. The coupling agent may be used to provide a lower melting temperature or glass transition temperature for the thermoplastic compatibilizer. A lower melting temperature or glass transition temperature facilitates the dispersion of the thermoplastic compatibilizer with the flash dried pulp. Since some coupling agents may be sensitive to residual moisture in the fibrous material, the precursor material may advantageously comprise at least 6% (w/w) of the thermoplastic compatibilizer, when the thermoplastic compatibilizer is a polymer that has been grafted to contain a coupling agent. Further, when the thermoplastic compatibilizer is a polymer that has been grafted to contain a coupling agent, an average particle size equal to or higher than 200 micrometers may be advantageous. When the average particle size of the thermoplastic compatibilizer is larger, the activity of the coupling agent may be better preserved. An advantage of using a polypropylene as a highly non-polar polymer with low surface energy, is the compatibility of the material with many commonly used compounding polymers, in particular with other polyolefins. A further advantage of using a polypropylene based thermoplastic compatibilizer is the improved water repellence, which may be obtained with even small additions of polypropylene based thermoplastic compatibilizer, such as less than 12% (w/w), for example about 10% (w/w).

As the obtained precursor product includes only a small amount of thermoplastic compatibilizer of 14% (w/w) or less, it provides an advantage that while this amount of thermoplastic compatibilizer facilitates the fiber-based polymer compounding, the compounder who manufactures a fiber-based composite product from the pulp precursor material, has still the freedom to decide the type and amount of polymer to be used in a fiber-based composite product.

The mixture may comprise also other additives, such as one or more lubricant(s) and/or one or more wax(es). Preferably the mixture comprises one or more wax(es). Also other additives, such as one or more of inorganic fillers, such as talc, fire retardant(s), pigment(s), surfactant(s), adsorption agent(s), property enhancer(s), adhesion promoter(s), rheology modifier(s), fire retardant(s), coloring agent(s), anti-mildew compound(s), antioxidant(s), uv-stabilizer(s), foaming agent(s), curing agent(s), coagent(s), catalyst(s) or the like may be included. Alternatively the mixture does not contain other additives besides the lubricant and/or wax. In one example the mixture or the formed precursor material contains only lubricant(s) or only wax(es), but not both, and optionally one or more other additive(s).

Lubrication is a technique of using a lubricant to reduce friction and/or wear in a contact between two surfaces. Typically lubricants contain 90% base oil and less than 10% additives. Due to their efficient lubricating effect, the lubricants significantly improve the flow characteristics and process behavior of compounds during extruding, molding, etc. Lubricants reduce viscosity, promote dispersion, shorten mixing times and lower mixing temperatures and energy requirements. Lubricants act on the surface of the pellets thus having an impact on the storability, flow, processability and the like properties. Examples of lubricants suitable for the present applications include hydrocarbons, stearates, fatty acids, esters and amides, which may be modified with functional groups.

In general the precursor material may include a carrier such as a wax (universal carrier) or a specific polymer, identical or compatible with the polymer(s) used (polymer-specific). When a carrier different than the base plastic is used, the carrier material may modify the resulting plastic's properties.

The wax may comprise a modified wax, for example oxidized or functionalized, natural wax, or a synthetic or a specialty wax such as amide wax or metallocene wax, or a mixture thereof. In addition, the wax may be a paraffin wax, micro-crystalline wax, polyolefin wax, such as polyethylene, and/or polypropylene wax. The wax may comprise polar wax and/or non-polar wax, and it may be reactive wax. Examples of suitable waxes include polyolefin wax, such as low molecular weight polypropylene or polyethylene wax, for example reactive wax comprising modified polyethylene or polypropylene, such as silane-modified polyethylene or polypropylene, and polyethylene or polypropylene wax, which may be provided for example in powdery form or in granulate form. The wax is then mixed and melted. The wax may help suppressing the hygroscopic properties of the fiber material, which facilitates the storability and prolongs the shelf life of the precursor material. Especially synthetic waxes are preferred.

The amount of the lubricant(s) and/or wax(es) may be in the range of 0-1 (w/w), such as 0.1-1% (w/w). It was found out that amounts in the range of 0.1-0.6, such as 0.1-0.5, 0.2-0.6 or 0.3-0.5 were enough for most cases. It was also noted that the amount of the lubricant and/or wax should not be too high. For example if the content of wax was 2% (w/w), the formed pellets did not hold together. The same was also noticed with lubricants, even with smaller doses. Such material is not suitable for storing, transporting or handling. The mixture or the formed precursor material preferably does not contain mineral oil.

A surfactant, in general, is a molecule that contains both a hydrophobic and hydrophilic end group. Cationic surfactants are examples of a molecule which can be arranged to adsorb onto a surface of cellulose fibers, thereby lowering the free energy of the interphase between cellulose fiber surface and a polymer. Usually, the hydrophobic group consists of one or several hydrocarbon chains, while the hydrophilic group is an ionic or highly polar group. Cationic surfactant adsorption onto cellulose fiber surfaces of bleached chemical pulp inhibits the generation of fiber-networks. The addition of cationic surfactants may thus reduce agglomeration and enhance the dispersion of cellulose fibers into polymer containing composites. A cationic surfactant that may act as adsorption agent can be, for example, a polyallylamine or a strong cationic surfactant containing one long hydrocarbon chain or two hydrocarbon chains. Besides cationic surfactants, also cationic polyelectrolytes may act as adsorption agent with bleached chemical pulp containing cellulose fibers. Cationic polyelectrolytes can be adsorbed onto the surface of the cellulosic fibers through electrostatic interactions, thereby saturating the fiber surface and inducing a charge reversal. However, the adsorption phenomenon varies depending on the properties of polyelectrolyte. An example of a polyelectrolyte that may act as adsorption agent can be, for example, a cationic, branched polyethyleneimine containing terminal amine groups (—NH₂), which may be protonated into amino groups (—NH₃⁺) in acidic conditions. Of particular interest are silane based compounds that may act as adsorption agents with bleached chemical pulp containing cellulose fibers. In particular, organosilanes containing amine or vinyl functional groups, especially aminosilanes and vinylsilanes such as aminopropyltriethoxysilane APTES and vinyltriethoxysilane VTES, have been observed to show nearly linear adsorption behaviour onto the surface of the cellulosic fibers. This has been surprising, since in aqueous solutions silane compounds have a polymerization tendency, which decreases the rate of adsorption. When the adsorption agent contains functional groups, such as amine groups of vinyl groups or cationic sites, the agent may be arranged to improve the affinity towards the thermoplastic compatibilizer upon compounding. Amine group (—NH₂), for example, is reactive with maleic anhydride. Maleic anhydride may be present in a thermoplastic compatibilizer that is added to the flash dried pulp containing cellulose fibers, when manufacturing pulp precursor material. Of notice is, that in addition to improved affinity towards the thermoplastic compatibilizer in the method, cellulose fiber surfaces containing silane compounds have furthermore shown a fiber debonding effect, such that formation of cellulose fiber agglomerates prior to mixing the thermoplastic compatibilizer may be reduced.

The ingredients may be formed into a mixture comprising
80-95% (w/w) of cellulosic fibers,
3-7% (w/w) of coupling agent,
0-7% (w/w) of thermoplastic polymer, such as 3-7% (w/w), and
0-1% (w/w) of lubricant and/or wax, such as 0.1-0.6% (w/w).

In one example the ingredients are formed into a mixture comprising
85-94% (w/w) of cellulosic fibers,
3-7% (w/w) of coupling agent,
3-7% (w/w) of thermoplastic polymer, and
0-0.6% (w/w) of lubricant and/or wax, such as 0.1-0.6% (w/w).

In one example the ingredients are formed into a mixture comprising
90-93% (w/w) of cellulosic fibers,
3.5-5% (w/w) of coupling agent,
3.5-5% (w/w) of thermoplastic polymer, and
0-0.6% (w/w) of lubricant and/or wax, such as 0.1-0.6% (w/w).

The ingredients may be formed into a mixture comprising
80-94% (w/w) of cellulosic fibers, such as 85-94% (w/w), or 90-93% (w/w),
5-14% (w/w) of thermoplastic compatibilizer, such as 6-14% (w/w), 8-14% (w/w) or 10-14% (w/w), and
0-1% (w/w) of lubricant and/or wax, such as 0.1-0.6% (w/w).

Further filler(s) and/or additives may be included, as disclosed herein, which may be customary in the art.

Suitable forming device(s) and other devices for preparing pellets or the like may be provided. For example the method may comprise providing one or more mixer(s), one or more compacting device(s) and/or one or more device(s) for feeding the ingredients into the device(s). The cellulosic fibers may be fed into a mixer, such as into a hot-cold mixer, for example a non-compression hot-cold mixer, or a speed mixer. Examples of the mixers include a Z-blade mixer, a batch type internal mixer, an extruder, a heating mixer and/or a heating/cooling mixer. Preferably the mixer is arranged to heat the mixture.

The cellulosic fibers may be mixed with the coupling agent, optionally with the thermoplastic polymer and optionally with the lubricant and/or wax.

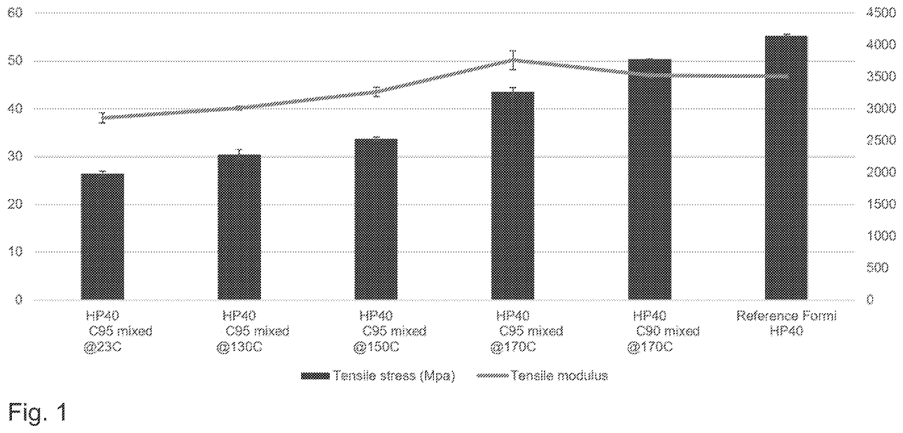

The method usually comprises forming the pellets in a melt process, or by melt processing the mixture, which refers to a process including at least one melting step. The method may comprise heating the coupling agent and/or thermoplastic polymer, optionally the mixture, to obtain a melt. The melt refers to full or partial melt of components which can be melted at the temperatures used, such as thermoplastic polymer(s), coupling agent(s), wax(es), lubricant(s) and/or applicable additives. The coupling agent, the wax and/or thermoplastic polymer may be heated first, and the obtained melt may be then combined with the cellulosic fibers and/or other ingredients. A mixture comprising fibers, thermoplastic polymer(s) and coupling agent(s) may be also heated first, and wax(es), lubricant(s) and/or other additives may be added to the obtained melt. However it was noticed that all the ingredients can be mixed and processed at once without compromising the quality of the obtained products, which simplifies the process. In one embodiment the mixing, or the forming of the mixture, comprises melt processing, such as melt processing the mixture or one or more ingredients of the mixture. It may be carried out as a hot/cold mixing process, for example with a heating/cooling mixer. In one embodiment the mixing is carried out with a non-compression mixer. Products were obtained already by processing at ambient temperature, but to obtain higher mechanical properties, a temperature of at least 130° C., at least 150° C., or preferably at least 170° C. may be used, as shown in FIG. 1. The processing temperature may refer to mixing and/or compacting temperature, and it may be for example in the range of 160-200° C., 160-180° C., or 165-175° C.

The obtained mixture may be pelletized into pellets of desired size by using a suitable compacting method and device, such as pelletizing device and method. For example the mixture is compressed in a compacting device or unit, which may be configured to provide pellets having a desired bulk density.

The method comprises forming said mixture into granules or pellets to obtain the natural fiber plastic composite precursor material, preferably pellets. The pellets may have a bulk density in the range of 300-700 g/l, such as 300-660 g/l or 300-600 g/l (kg/m³). More particularly the mixture may be compacted such that said bulk density is obtained. High bulk density indicates that the pellets contain a high amount of fibers. Such pellets enable including a large amount of fibers in a smaller volume, which for example lowers transport costs. Also pellets with high bulk density are easy to feed into processing devices. However pellets having a bulk density over 700 g/l may be difficult to disintegrate in the forming device during compounding.

Bulk density is defined as the mass of particles that occupies a unit volume of a container. Bulk density of granular and powdery materials can be determined by the ratio of the mass to a given volume. Determination of bulk density can be done, for example, by filling a container of known dimensions and weight with the material of interest and by weighing the container containing the material of interest. Bulk density depends on particle size, particle form, material composition, moisture content, as well as on material handling and processing operations. For example, rounded particles will be closer together when poured into a container compared to non-spherical particles, such as fibers.

The bulk density as used herein may refers to apparent bulk density of the organic natural fiber material and/or to calculated bulk density of the organic natural fiber material.

The apparent bulk density is measured bulk density of the organic natural fiber material, and it is typically neither compressed nor decompressed. The calculated bulk density depends on the amount of organic natural fiber material in a certain volume, and it comprises also compressed and decompressed bulk densities.

Bulk density ρ of the organic natural fiber material is calculated by dividing the weight of the sample by its volume as follows:

$$ρ = \frac{mass of fibre}{volume of fibre} \qquad Eq . ( 1 )$$

Organic fiber material is, however, very soft and bulky and that is why the bulk density can be increased a great deal by compressing or pressing the organic natural fiber material.

The determination of bulk density can be done, for example, according to ISO 697 and ISO 60 (valid 2011), and their counterparts in other standards organizations, and by other similar measurement procedures that would ensure reasonable results in the determination of bulk density. In addition, bulk density can be determined with devices such as Powder Characteristics Tester by Hosokawa and Powder Flow Tester by Brookfield, and with other similar devices intended for determination of different characteristics of powdery materials. Bulk density can also be measured by suitable laboratory and on-line measurement sensors including, but not limited to, techniques based on microwaves. Bulk density of organic natural fiber material can be determined as described above.

Calculated bulk density ρ_{calculated} is the bulk density the organic fiber material would have, if the material would be evenly distributed to the volume that is available at given time. Calculated bulk density ρ_{calculated} of fiber for batch, i.e. discontinuous, process can be determined as follows:

$${ρ}_{calculated} = \frac{mass of fibre}{available , free volume of mixer} \qquad Eq . ( 2 )$$

and for continuous process like this:

$${ρ}_{calculated} = \frac{mass flow of fibre}{conveying volumetric flow of mixer} \qquad Eq . ( 3 )$$

In one embodiments the method comprises forming said mixture into pellets having an average diameter in the range of 3-8 mm, such as 3-6 mm. A compression ratio for example of about 2:1 may be used, such as the mixture is compressed into an aperture having a diameter of 8 mm and outputted from an aperture having a diameter of 4 mm.

The pellets may be formed by compacting, more particularly the obtained mixture is fed into a compacting device or unit and compacted into pellets through a die or aperture having a desired diameter, such as a diameter in the range of 3-8 mm. It was found out that the outputted pellets easily formed a length:diameter ratio of about 3:1, which is suitable for most uses for this size of pellets. The outputted pellets had substantially even size distribution, which indicates that the fibers were well mixed. It was also found out that pellets having an average diameter less than 3 mm were not desired, because they were prone to break or crumble during handling and/or transport. A pellet diameter of about 4 mm was preferable for most uses. Such sized pellets were easy to feed into processing devices, such as into a mixer, an extruder, or other device in the manufacturing process of the final composite products at the site of production. Further, such pellets would be disintegrated in the processing device, such as during compounding, which facilitates the process and enables manufacturing products with homogenous structure.

An example of a compacting device is a strand pelletizer, wherein the mixture can be heated, compressed and conveyed to a die head, wherein the compressed material coming from the die head is converted into strands that are cut and/or formed into intermediate products, such as pellets, after cooling and solidification. Alternatively, a pelletizing process may be used, wherein the compressed material coming from the die head is cut and/or formed directly into intermediate products, such as pellets, followed by cooling, for example by means of an air-cooled die-face pelletizer. One example of a compacting device is an extruder, such as any of the extruders disclosed herein. The compacting step may or may not include heating and/or melt processing the materials.

Other additive(s), as disclosed herein, may be included to obtain 100% (w/w) of ingredients in the mixture or in the precursor material or product. One or such additive is inorganic filler, which may be included in an amount in the range of 0.1-10% (w/w), such as 0.5-5% (w/w). The inorganic filler may comprise kaolin clay, ground calcium carbonate, precipitated calcium carbonate, titanium dioxide, wollastonite, talcum (talc), mica, silica, or a mixture thereof. A preferred inorganic filler is talc. Talc may be used to enhance bulk density and/or to control the structural and/or mechanical properties of the obtained product.

The moisture content of the obtained pellets is relatively low, such as 5% (w/w) or less, preferably 3% (w/w) or less or even about 2% (w/w) or less. The moisture content will decrease during processing and pressing. For example from a mixture having a moisture content of about 7% (w/w) pellets with a moisture content of about 2% (w/w) were obtained.

The composition, pelletizing process and/or devices may be adjusted to obtain suitable pellet properties, such as hardness. Pellets which are too hard do not break properly during the mixing and extrusion process. The resulting pellet fragments show up as little bumps in the finished product and significantly decrease its mechanical properties. Pellets which are too soft on the other hand causes powder formation and thus challenges during feeding of the material or transportation. A suitable pellet hardness may be in the range of 100-200 N, such as 120-180 N.

The pellet hardness testers are available in two designs: testers with manually operated pressing screw and testers with motor-driven pressing screw. The same basic device may be used for both designs so that the drive is interchangeable. The pressing screw of the manually operated device is turned by hand periodically at different speeds. The measured values may slightly vary, depending on the operator in charge. The motor-driven tester, however, works independently of the operator and the results are completely neutral, so that the values of different plants can be used for comparison. Commercial pellet hardness testers are available for example from Amandus Kahl.

The present application provides a natural fiber plastic composite precursor material for compounding, the material comprising
80-95% (w/w) of cellulosic fibers having an average fiber length less than 1 mm,
3-7% (w/w) of coupling agent,
0-7% (w/w) of thermoplastic polymer, and
0-1% (w/w) of lubricant and/or wax, such as 0.1-0.5% (w/w), wherein the material is in form of pellets having a bulk density in the range of 300-700 g/l.

The precursor material may be prepared with the methods disclosed herein. When the fiber content is 95% or close, the amount of thermoplastic polymer may be minimal or zero, such as in the range of 0-1.9% (w/w), and the amount of the coupling agent may be in the range of 3-5% (w/w), such as 3-4.9 or 3-4% (w/w) leaving room for the 0.1-1% (w/w) of lubricant and/or wax.

The thermoplastic polymer and the coupling agent may together form a thermoplastic compatibilizer, especially in the final precursor product. Therefore in one embodiment the natural fiber plastic composite precursor material for compounding comprises
80-94% (w/w) of cellulosic fibers having an average fiber length less than 1 mm,
6-14% (w/w) of thermoplastic compatibilizer, and
0-1% (w/w) of lubricant and/or wax, such as 0.1-1.0% (w/w) or 0.1-0.5% (w/w), wherein the material is in form of pellets having a bulk density in the range of 300-700 g/l.

The obtained natural fiber plastic composite precursor material and products, especially in the form of pellets, exhibit good structural and mechanical properties, such as tensile stress and modulus, flexural stress and modulus and impact strength. Similarly the products obtained by using the precursor materials exhibited similar properties.

The obtained natural fiber plastic composite precursor material pellets or other particles may be packed in suitable packings, stored at a variety of conditions and transported to a location of use, which may be a different location from the location of manufacture. The operator using the precursor material may be a different operator from the manufacturer of the precursor material. The obtained precursor material tolerates packing, storing and transporting well and different kinds of packings, transporting methods and means and further processing means can be used. At the location of use the precursor material may be used for preparing natural fiber plastic composite products.

The present application provides a method for preparing a natural fiber plastic composite product, the method comprising
providing the natural fiber plastic composite precursor material disclosed herein,
providing plastic material, such as thermoplastic polymer,
feeding the natural fiber plastic composite precursor material and the plastic material to a forming device, and
forming the materials into a composite product.

The method may comprise providing a system comprising a forming device, which may be called as thermoplastic forming device, wherein the forming device is used for preparing the composite product. The compounding and/or forming may be carried out in the system or in the forming device. The system, or the forming device may comprise for example an extruder, an injection molding device or machine, such as injection press, which device(s) may be hydraulic, mechanical or electric, and/or other device disclosed herein. The precursor material and the plastic material, and optionally one or more additives, are combined to form a mixture. The method may comprise mixing the materials, for example in one or more mixing steps, before, during and/or after feeding into the forming device. The precursor material and the plastic material are provided in amounts resulting in desired fiber and/or plastic content in the final product. Therefore the content of the mixture and the final product may be controlled by adjusting the amount of the precursor material dosed to the system. The form and the shape of the precursor material enables free flow of material and accurate control of the dosing and/or feeding. The properties of the precursor material are especially important in continuous methods, such as extrusion, wherein there is a continuous flow of the materials into the system or into the forming device wherein the dosing, the feeding and/or the flow need to be controlled.

The system or the forming device may comprise a mixer for mixing the precursor material and the plastic material. The mixing is carried out in one or more mixing stage(s) or step(s). This mixer may be a first mixer and the mixing stage may be a first mixing stage or a primary mixing stage. The system or the forming device may contain also a second mixer or further mixer(s), such as for mixing one or more of the additives in a further mixing step(s), for example lubricant(s), wax(es), filler(s), and/or other additive(s) disclosed herein. One or more, or all, of the additives may be also provided to the first mixer and mixed in the first mixer. A mixing step comprises introducing the ingredients to a mixer and mixing with the mixer to form a mixture. The mixer may be a hot-cold mixer. The ingredients may be melt processed during mixing and/or after mixing.

The method for preparing a natural fiber plastic composite product may comprise one or more of the following steps:
introducing the precursor material to the system,
introducing the plastic material to the system,
pre-mixing the precursor material before a (primary) mixing stage,
treating chemically the precursor material before a (primary) mixing stage,
pre-mixing the precursor material and unmolten plastic material before a (primary) mixing stage,
melting the plastic material at least partly,
contacting the at least partly molten plastic material with the precursor material,
mixing the at least partly molten plastic material with the precursor material in the (primary) mixing stage in order to form a mixture,
forming a composite product comprising the mixture.

The precursor material pellets may be introduced, for example fed, into an inlet of the system or the forming device, which may comprise a feeder, a hopper, a funnel or the like part or structure, wherefrom it flows into the system and/or to the forming device. The pellets may be crushed in the system and/or in the forming device to facilitate the compounding and/or formation of the mixture. The pellets having the bulk density and size according to the embodiments were efficiently degraded and mixed in the process, such as in an extruder, so a homogenous mixture and product were obtained.

The plastic material and the precursor material may be contacted with each other before a contacting step or in a contacting step of the primary mixing stage. If the plastic material and the precursor material are contacted before the contacting step of the primary mixing stage, the contacting step does not start until the plastic material at least starts to melt, i.e. at least 10% (w/w) of the plastic material is in melt form.

The mixture comprising precursor material and the molten plastic material may be formed so that the precursor material has been incorporated to the melt plastic material without use of compression during the contacting step. In one example the mixing of the primary mixing stage is made without the compression regardless of mixing method and mixing type. However, in another example the composite product is formed from the mixture under heat and pressure.

Wetting of the fiber material with the plastic material can be secured during the primary mixing stage. Therefore, the fiber material can be spread evenly among the plastic matrix material and the fibers can be wetted evenly with the matrix material. Forming of covalent or strong physical bonds or strong mechanical attachment between the fibers of the fiber material during the primary mixing stage can be prevented. Further, adhesion of the fibers of the fiber material to the matrix material can be secured and a composite product without fiber agglomerates can be obtained. The primary mixing stage is preferably a part of a continuous process. However, the primary mixing stage may also be implemented in a batch process.

In the method the thermoplastic polymer material, i.e. the plastic material, is provided in melt form, either fully or partly melt. The thermoplastic polymer material is, at least partly, in melt form, when the cellulosic fiber material can adhere to the thermoplastic polymer material, and/or the melt flow index of the material can be measured (according to standard ISO 1133 (valid in 2011)), and/or the cellulosic fiber material can adhere to the surfaces of thermoplastic polymer material particles.

Preferably at least 10% or at least 30%, more preferably at least 50% or at least 70% and most preferably at least 80% or at least 90% of the thermoplastic polymer material is in melt form in the contacting step of the primary mixing stage. Preferably, at least 20% or at least 40%, more preferably at least 60% or at least 80% and most preferably at least 90% or at least 95% of the thermoplastic polymer material is in melt form at least momentarily during the primary mixing stage.

The melting point of the thermoplastic polymer material may be under 250° C., such as under 220° C., and for example under 190° C. The glass transition temperature of the thermoplastic polymer material may be under 250° C., such as under 210° C., and for example under 170° C.

The melt flow rate, MFR, of the thermoplastic polymer material may be under 1000 g/10 min (230° C., 2.16 kg defined by ISO 1133, valid 2011), such as 0.1-200 g/10 min, for example 0.3-150 g/10 min. Preferably the melt flow rate of the thermoplastic polymer material is over 0.1 g/10 min (230° C., 2.16 kg defined by ISO 1133, valid 2011), such as over 1 g/10 min, for example over 3 g/10 min.

The composite product comprising the mixture may be formed by means of a mixing device, an internal mixer, a kneader, a pelletizer, a pultrusion method, a pull drill method, and/or an extrusion device. In one embodiment the method comprises forming the materials, more particularly the mixture of the materials, into a composite product in a melt process, such as by extruding and/or by injection moulding. The forming the materials into a composite product may be carried out as a continuous process or as a batch process, or as a combination thereof.

The contacting step is carried out in a process place or area, in which the precursor material comes in contact with the at least partly molten plastic material. Preferably the plastic material is in a melt form during the contacting step, i.e. the plastic material is arranged in the form of melt at least in the contacting step in which the precursor material comes in contact with the melt plastic material. Therefore, the plastic material is preferably heated so that the temperature of the plastic material is higher than the glass transition temperature or, if the plastic material has a melting temperature, the plastic material is heated higher than the glass transition and melting temperatures, before the contacting step of the primary mixing stage starts. In the melting, phase transition is from solid to melt.

The method for preparing the natural fiber plastic composite product may further comprise providing one or more additives, such as one or more lubricant(s), wax(es), inorganic fillers, fire retardant(s), pigment(s), surfactant(s), adsorption agent(s), property enhancer(s), adhesion promoter(s), rheology modifier(s), fire retardant(s), coloring agent(s), anti-mildew compound(s), antioxidant(s), uv-stabilizer(s), foaming agent(s), curing agent(s), coagent(s), catalyst(s) or combinations thereof. The additive(s) may be mixed with other ingredients at any suitable stage or place.

In one example the primary mixing stage is implemented with an extruder. In this case, after the primary mixing stage, the extruder is preferably also used to form the composite product.

In one example the mixture containing the precursor material and the plastic material is extruded. In one example, the mixture is extruded after at least one pre-treatment. In one example the precursor material is supplied into the extrusion directly. In one example the plastic material is mixed with the precursor material in connection with the extrusion, preferably without any pre-treatment stage.

In the case of the extrusion, any suitable single-screw extruder or twin-screw extruder, such as a counter-rotating twin-screw extruder or a co-rotating twin-screw extruder, may be used. The twin-screw extruder may have parallel or conical screw configuration. The pellets of the embodiments can be efficiently used in a variety of forming devices, not only in different types of extruders.

In one example, the melt of the mixture comprising the precursor material and the plastic material is conveyed to a co-rotating parallel twin screw extruder, through melt pump to die plate to form strand of the mixture. In one example, a co-rotating conical twin-screw extruder is used for the composite production. The screw volume may be, for example, from 4 to 8 times bigger at the beginning of the screw than in the end of the extruder.

One example of the extrusion comprises compounding with a co-rotating twin screw extruder. One example of the extrusion comprises compounding with a conical counter-rotating twin screw extruder. In this case, material components are fed into main feed of the compounding extruder at the beginning of the screws so melting can start as soon as possible. One example of the extrusion comprises compounding with a single screw extruder with screening unit. In this case, material components are fed into main feed of the extruder at the beginning of the screws so melting can start as soon as possible.

The obtained composite products have a good dispersion. Dispersion is a term that describes how well other components are mixed with the matrix material, preferably with the polymer matrix, and/or other carrier material. Good dispersion means that all other components are evenly distributed into material and all solid components are separated from each other i.e. all particles or fibers are surrounded by matrix material, i.e. the plastic, and/or other carrier material.

In some examples the composite product is in a form of or is a part of a decking, a floor, a wall panel, a railing, a bench, for example a park bench, a dustbin, a flower box, a fence, a landscaping timber, a cladding, a siding, a window frame, a door frame, indoor furniture, a construction, an acoustic element, a package, a part of an electronic device, an outdoor structure, a part of a vehicle, such as an automobile, a road stick for snow clearance, a tool, a toy, a kitchen utensil, cookwear, white goods, outdoor furniture, a traffic sign, sport equipment, containers, pots, and/or dishes, and/or a lamp post.

The present application provides use of the natural fiber plastic composite precursor material disclosed herein for preparation of any of the natural fiber plastic composite products disclosed in previous.

### Examples

Dry pulp sheets were received from a pulp mill. The sheets were grind and sieved to obtain a desired particle size and an average fiber length below 0.5 mm. HC or heated speed mixer was used to melt and mix plastic carrier and coupling agent provided as powders. Additives were added and a variety of mixtures with different compositions were formed. Finally the mixtures were pelletized with a compacting device to obtain pulp fiber masterbatch pellets with a diameter of 4 mm, a moisture content of less than 0.5% (w/w) and a fiber content of about 90% (w/w) or even about 95% (w/w).

The effect of processing temperature on mechanical properties in the melt-blending of the masterbatch was studied, and the results are shown in FIG. 1. Tensile stress is visualized with the bars and tensile modulus with the line. C90 and C95 refer to the fiber content of the product (90% and 95%, respectively).

The masterbatch pellets were used for compounding natural fiber plastic composite products. The pellets were easy to handle, store and apply into an extruder. The pellets were also disintegrated in the extruder and a homogenous mixture was formed at 170° C. containing 40% fiber in polypropylene matrix. Finally the products were injection molded into products. Elongated flat composite products (test bars) were formed from different materials. HP40 refers to 40% fiber compound in polypropylene matrix.

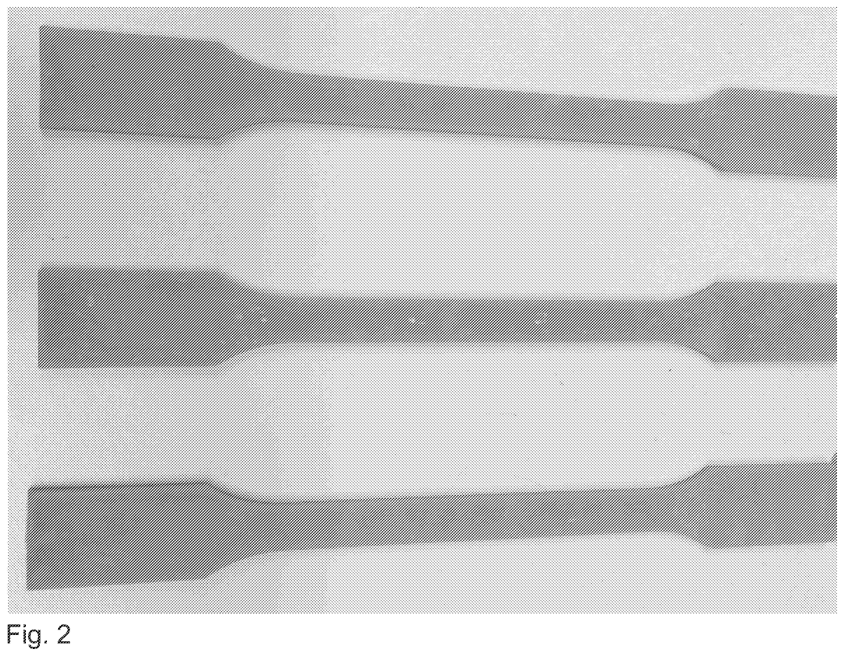

Color and fiber distribution were evaluated visually as can be seen in FIG. 2. The uppermost sample is a reference corresponding a commercial composite material UPM Formi by UPM containing 40% (w/w) bleached pulp fiber in polypropylene matrix. The middle sample contains 40% (w/w) birch fiber in polypropylene matrix compounded from a masterbatch with 95% fiber content (C95). The lowermost sample contains 40% (w/w) birch fiber in polypropylene matrix compounded from a masterbatch with 90% fiber content. It can be seen from the figure that the middle sample obtained from pellets containing only fibers and coupling agent contains visible white fiber bundles and is not as homogenous as the lowermost sample obtained from pellets further containing polypropylene matrix.

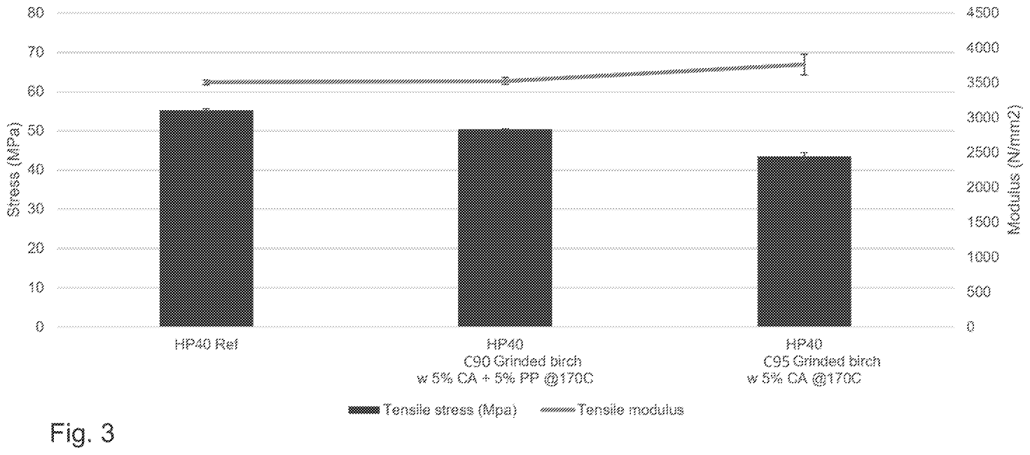

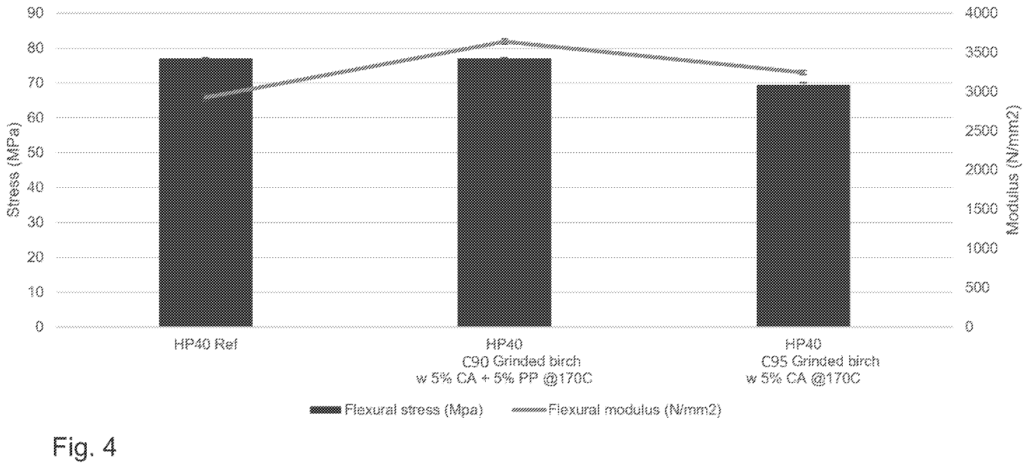

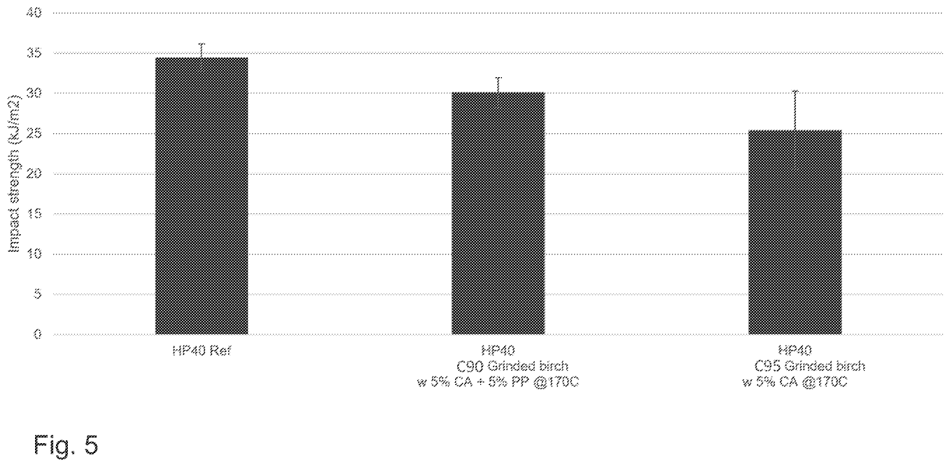

The samples were tested for tensile stress and tensile modulus (FIG. 3), flexural stress and flexural modulus (FIG. 4) and impact strength (FIG. 5). Tensile stress and flexural stress are visualized with the bars and tensile modulus and flexural modulus with the lines.

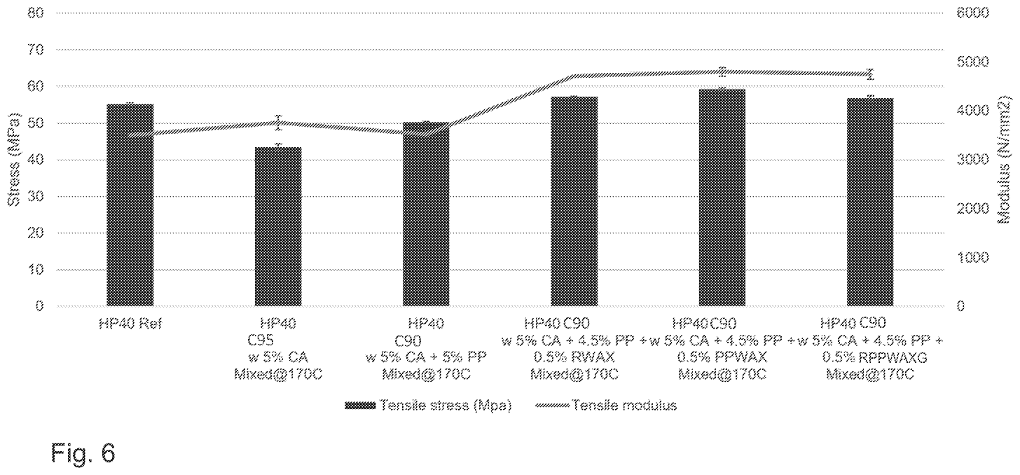

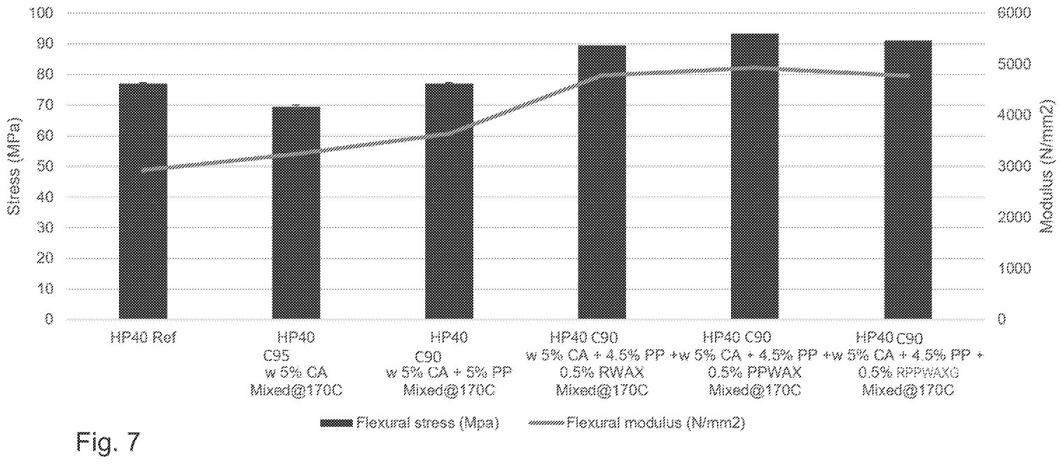

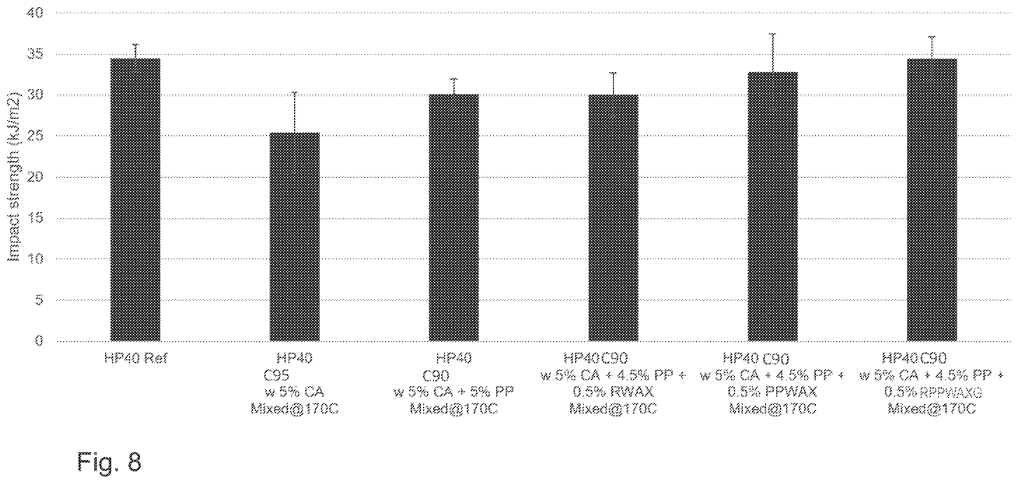

Pulp fiber masterbatch pellets were prepared by including wax or wax-based lubricant as additives. The effect of these additives were studied by testing the samples for tensile stress and tensile modulus (FIG. 6), flexural stress and flexural modulus (FIG. 7) and impact strength (FIG. 8). As a coupling agent (CA) maleic anhydride base coupling agent was used in an amount of 5% (w/w). Polypropylene was used as a polymeric matrix material in amount of 4.5-5% (w/w), but it was possible to obtain pellets by using only 5% (w/w) coupling agent and 95% (w/w) fibers. The waxes used were powdery reactive wax comprising silane linked to polypropylene (RWAX), powdery polypropylene wax (PPWAX) and silane-modified reactive polypropylene wax in granulate form (RPPWAXG).

The composite products obtained by using the precursor material in compounding exhibited tensile stress in the range of 43-60 MPa. Especially when the precursor products also contained polyolefin, such as polypropylene, the tensile stress was higher, in the range of 50-60 MPa. Further, when wax or lubricant was included the tensile stress was even higher, such as in the range of 57-60 MPa. The tensile modulus of the products was in the range of 3500-4850 N/mm², such as 3700-4850 N/mm² or 4500-4850 N/mm². It was noticed that when precursor products containing only fibers and coupling agent were used even higher tensile modulus of about 3760 N/mm² was obtained, which was higher than the tensile modulus of the reference products. When wax or lubricant was included the tensile modulus was significantly higher, in the range of 4700-4850 N/mm².

The composite products obtained by using the precursor material in compounding exhibited flexural stress in the range of 70-95 MPa, such as 75-95 MPa when the precursor products contained also polyolefin, such as polypropylene. Further, when wax or lubricant was included the flexural stress was even higher, such as in the range of 85-95 MPa, such as 89-94 MPa. The flexural modulus was in the range of 3250-5000 N/mm², such as 3600-5000 N/mm², even 4500-5000 N/mm² when precursor products containing wax or lubricant were used.

The impact strength of the composite products was in the range of 25-35 kJ/m², such as 30-35 kJ/m² for products containing also polyolefin, such as polypropylene. Further, when wax or lubricant was included the impact strength was even higher, such as in the range of 32-35 kJ/m². The impact strength as Charpy impact strength of compound may be determined according to EN ISO 179-2, for example by using method ISO 179-2/1fU (unnotched).

It was noticed in tests that conventional lubricants are often too effective and may lubricate the mixture too much so the pellets did not hold together. However, wax-containing mixtures behaved in different way and pellets could be formed without problems.

1. A method for preparing a natural fiber plastic composite precursor material for compounding, the method comprising
forming a mixture comprising
80-95% (w/w) cellulosic fibers having an average fiber length less than 1 mm,
3-7% (w/w) coupling agent,
0-7% (w/w) thermoplastic polymer,
0-1% (w/w) lubricant and/or wax, and
forming the mixture in a melt process into pellets having a bulk density in the range of 300-700 g/l to obtain the natural fiber plastic composite precursor material.

2. The method of claim 1, comprising forming the ingredients into a mixture comprising 85-94% (w w) cellulosic fibers.

3. The method of claim 1, comprising forming the ingredients into a mixture comprising 1-7% (w/w) thermoplastic polymer.

4. The method of claim 1, wherein the cellulosic fibers have an average fiber length of 0.7 mm or less.

5. The method of claim 1, wherein the cellulosic fibers comprise pulp.

6. The method of claim 1, wherein the cellulosic fibers comprise recycled cellulosic fibers.

7. The method of claim 1, wherein the cellulosic fibers have a bulk density in the range of 40-100 g/l.

8. The method of claim 1, wherein the forming of the mixture is carried out as a hot/cold mixing process and/or with a non-compression mixer.

9. The method of claim 1, wherein, wherein the pellets have an average diameter in the range of 3-8 mm.

10. The method of claim 1, wherein the thermoplastic polymer comprises polyolefin.

11. The method of claim 1, wherein the lubricant comprises one or more wax-based lubricant(s) and/or hydrocarbons, stearates, fatty acids, esters and/or amides, which may be modified with functional groups.

12. The method of claim 1, wherein the wax comprises polyolefin wax.

13. The method of claim 1, wherein the coupling agent comprises maleic anhydride based coupling agent.

14. A natural fiber plastic composite precursor material for compounding, the material comprising
80-95% (w/w) cellulosic fibers having an average fiber length less than 1 mm,
3-7% (w/w) coupling agent,
0-7% (w/w) thermoplastic polymer, and
0-1% (w/w) lubricant and/or wax, wherein the material is in form of pellets having a bulk density in the range of 300-700 g/l.

15. The natural fiber plastic composite precursor material of claim, comprising 85-95% (w/w) cellulosic fibers, such as 90-94% (w/w) or 91-95% (w/w).

16. The natural fiber plastic composite precursor material of claim 14, the material comprising 1-7% (w/w) thermoplastic polymer.

17. The natural fiber plastic composite precursor material of claim 14, wherein the cellulosic fibers have an average fiber length of 0.7 mm or less.

18. The natural fiber plastic composite precursor material of claim 14, wherein the cellulosic fibers comprise pulp, such as chemical pulp.

19. The natural fiber plastic composite precursor material of claim 14, wherein the cellulosic fibers comprise recycled cellulosic fibers.

20. The natural fiber plastic composite precursor material of claim 14, wherein the pellets have an average diameter in the range of 3-8 mm.

21. The natural fiber plastic composite precursor material of claim 14, wherein the thermoplastic polymer comprises polyolefin.

22. The natural fiber plastic composite precursor material of claim 14, wherein the lubricant comprises one or more wax-based lubricant(s) and/or hydrocarbons, stearates, fatty acids, esters and/or amides, which may be modified with functional groups.

23. The natural fiber plastic composite precursor material of claim 14, wherein the wax comprises polyolefin wax.

24. The natural fiber plastic composite precursor material of claim 14, wherein the coupling agent comprises maleic anhydride based coupling agent.

25. The natural fiber plastic composite precursor material of claim 14 obtained with the method of claim 1.

26. A method for preparing a natural fiber plastic composite product, the method comprising
providing the natural fiber plastic composite precursor material of claim 14,
providing thermoplastic polymer,
feeding the natural fiber plastic composite precursor material and the thermoplastic polymer to a forming device, and
forming the materials into a composite product.

27. The method of claim 26, comprising forming the materials into a composite product in a melt process by extruding and/or by injection moulding.

28. (canceled)

29. The method of claim 1, comprising forming a mixture comprising 0.1-0.6% (w/w) lubricant and/or wax.

30. The natural fiber plastic composite precursor material of claim 14 comprising 0.1-0.6% (w/w) lubricant and/or wax.
